(19) United States
(12) Patent Application Publication
(10) Pub. No.: US 2017/0063699 A1
(43) Pub. Date: Mar. 2, 2017

(54) METHOD AND APPARATUS FOR CONFIGURING MULTI-PATHS USING SEGMENT LIST

(71) Applicant: ELECTRONICS AND TELECOMMUNICATIONS RESEARCH INSTITUTE, Daejeon (KR)

(72) Inventor: Jeong Yun KIM, Daejeon (KR)

(21) Appl. No.: 15/247,094

(22) Filed: Aug. 25, 2016

(30) Foreign Application Priority Data
Aug. 26, 2015 (KR) 10-2015-0120084
Jan. 12, 2016 (KR) 10-2016-0003744

(51) Int. Cl. H04L 12/851; H04L 12/841; H04L 12/857; H04L 12/707; H04L 12/801

(52) U.S. Cl. CPC H04L 47/2425; H04L 45/24; H04L 47/34; H04L 47/2491; H04L 47/283

(57) ABSTRACT

A method and an apparatus for configuring multi-paths that are made by means of MPTCP using a segment list which determine and configure a network path so as to minimize a difference in capability between paths in configuring the multi-paths.

### CROSS-REFERENCE TO RELATED APPLICATIONS

This application claims priority to and the benefit of Korean Patent Application Nos. 10-2015-0120084 and 10-2016-0003744, filed in the Korean Intellectual Property Office on Aug. 26, 2015 and Jan. 12, 2016, respectively, the entire contents of which are incorporated herein by reference.

### BACKGROUND OF THE INVENTION

1. Field of the Invention

The present invention relates to a method and an apparatus for configuring multi-paths, and particularly, to a method and an apparatus for configuring multi-paths using a segment list.

2. Description of Related Art

As propagation of smart phones extends, while it is gradually generalized that one terminal has various communication interfaces including WiFi, 3G, LTE, and the like, researches for increasing transmission efficiency have been in progress by simultaneously using multiple network paths in communication between terminals. A multi-path TCP (MPTCP) as a transport layer protocol which is standardized in Internet engineering task force (IETF) can transmit data by simultaneously using various communication interfaces having different Internet protocol (IP) addresses.

The method can obtain a transmission gain by comparing with a single path when capabilities of the respective transmission paths are similar to each other, but when a difference (e.g., round-trip time (RTT), loss rate, and the like) in capability between the transmissions paths occurs, packets can arrive while arrival orders of the packets are changed, and as a result, an additional delay can occur at a receiving side. Further, since the respective transmission paths independently operate in the current MPTCP, when packet loss occurs on a path having a low capability, a relatively long time is required for recovering the packet loss, and as a result, the capability deteriorates.

FIG. 1 is a diagram for describing a method for configuring multi-paths in the related art. As illustrated in FIG. 1, when a host supporting the MPTCP transmits data to a server, and the like on a network through respective subflows by using multi-paths (e.g., simultaneously using LTE and WiFi), the difference (RTT, loss rate, and the like) in capability between the transmission paths can be large according to characteristics of access technologies such as the LTE and the WiFi in the host. Further, a transmitted packet can experience another delay and loss according to a state of a selected network path. In addition, even when the server connected to the network transmits the data to the host, and the like in a wired manner, the corresponding packet experiences another transmission capability according to the selected network path. In FIG. 1, in order to simply express the difference in transmission capability between the network paths, a case is shown in which high delay (high RTT) and low delay (low RTT) paths are provided.

When the network path is selected by a random or round robin mode in multi-path transmission, larger delay is experienced than single-path transmission and the reason is that the delay occurs until data having a predetermined size, which is to be transferred to an application at the receiving side is received due to the difference in capability (the delay, and the like) between the transmission paths selected by the respective subflows. As a result, in particular, when a transmissions delay of a first subflow is larger than that of a second subflow, there is a problem in that a data receiving delay at the receiving side also further increases.

### SUMMARY OF THE INVENTION

The present invention has been made in an effort to provide a method and an apparatus for configuring multi-paths using a segment list, which determines and configures a network path so as to minimize a capability difference between paths in configuring the multi-paths.

The technical objects of the present invention are not limited to the aforementioned technical objects, and other technical objects, which are not mentioned above, will be apparently appreciated to a person having ordinary skill in the art from the following description.

An exemplary embodiment of the present invention provides a method for operating a path controller for configuring multi-paths that are made by means of Multi-path Transmission Control Protocol (MPTCP), the method including: receiving a path request message for each subflow transmitted by a host in order to transmit a data packet from the host to a server through a plurality of subflows; and transmitting a path response message including transmission path information of a transmission delay range based on a predetermined service level agreement (SLA) value by referring to network path information, segment routing information and the quality of service (QoS) information of a network path stored in a database, wherein the transmission path information includes a segment list constituted by unique identifiers for respective routers through which the packet passes in order on a transmission path and the host transmits the data packet to the server so as to pass through each router of the segment list based on the segment list.

The unique identifier for each router may be a predetermined figure or an Internet protocol (IP) address.

The host may attach the segment list to the packet and transmit the packet to the router and each router on the transmission path transmits the packet by a host based multi-path routing scheme in which the packet attached with the corresponding segment list from which the segment corresponding thereto is deleted is transmitted to a next router or as the path controller transmits 5-tuple information and the transmission path information to a head-end router of the host, when the host transfers the packet to the head-end router, the head-end router may transmit the packet by a network based multi-path routing scheme in which the corresponding packet to which the segment list corresponding to the 5-tuple information is added is transmitted to the next router by referring to the segment list.

The 5-tuple information may include a source IP address, a destination IP address, a protocol, a source port number, and a destination port number.

The transmitting of the path response message including transmission path information of the transmission delay range based on the SLA value to the host may include selecting a transmission path which satisfies a transmission delay of the SLA value or less with respect to the path request message for a first subflow from the host, and selecting a transmission path which satisfies a transmission delay within a predetermined difference range in the previous transmission delay with respect to the path request message for subflows after a second subflow from the host. The difference range may be predetermined so that the transmission delay is smaller than that of a single-path transmission method.

The transmitting of the path response message including transmission path information of the transmission delay range based on the SLA value to the host may include determining the transmission path by further giving a weighted value to a transmission delay characteristic of an access interval between the access interval and a network interval for the host.

Another exemplary embodiment of the present invention provides a path controller for configuring multi-paths that are made by means of Multi-path Transmission Control Protocol (MPTCP), the path controller including: a communication unit; a database storing network path information, segment routing information, and quality of service (QoS) information of a network path; and a control unit receiving, in order to transmit a data packet from a host to a server through a plurality of subflows, a path request message for each subflow, which is transmitted by the host through the communication unit and transmitting to the host a path response message including transmission path information within a transmission delay range based on a predetermined service level agreement (SLA) value by referring to the information of the database, wherein the transmission path information includes a segment list constituted by unique identifiers for respective routers through which the packet passes in order on a transmission path and the host transmits the data packet to the server so as to pass through each router of the segment list based on the segment list.

The unique identifier for each router may be a predetermined figure or an Internet protocol (IP) address.

The host may attach the segment list to the packet and transmit the packet to the router and each router on the transmission path may transmit the packet by a host based multi-path routing scheme in which the packet attached with the corresponding segment list from which the segment corresponding thereto is deleted is transmitted to a next router or as the control unit transmits 5-tuple information and the transmission path information to a head-end router of the host, when the host transfers the packet to the head-end router, the head-end router may transmit the packet by a network based multi-path routing scheme in which the corresponding packet to which the segment list corresponding to the 5-tuple information is added is transmitted to the next router by referring to the segment list.

The control unit may perform, in order to transmit the path response message including the transmission path information of the transmission delay range based on the SLA value to the host, selecting a transmission path which satisfies a transmission delay of the SLA value or less with respect to the path request message for a first subflow from the host, and selecting a transmission path which satisfies a transmission delay within a predetermined difference range in the previous transmission delay with respect to the path request message for subflows after a second subflow from the host. The difference range may be predetermined so that the transmission delay is smaller than that of a single-path transmission method.

The control unit may determine the transmission path by further giving a weighted value to a transmission delay characteristic of an access interval between the access interval and a network interval for the host in order to transmit the path response message including the transmission path information of the transmission delay range based on the SLA value to the host.

According to exemplary embodiments of the present invention, a method and an apparatus for routing multi-paths configure a subflow transmission path by using a segment list so that a capability difference of a multi-path TCP maintains a predetermined range by effectively applying a multi-transmission control protocol (TCP) technique to improve capability deterioration which may occur due to a difference in capability between respective subflows of the multi-paths.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

### BRIEF DESCRIPTION OF THE DRAWINGS

FIG. 1 is a diagram for describing a method for configuring multi-paths in the related art.

FIG. 2 is a diagram for describing a method for routing multi-paths based on a host using a segment list according to an exemplary embodiment of the present invention.

FIG. 3 is a diagram for describing a method for routing multi-paths based on network using a segment list according to an exemplary embodiment of the present invention.

FIG. 4 is a block diagram for describing components of the path controller according to an exemplary embodiment of the present invention.

FIG. 5 is a diagram for describing a multi-path management table according to an exemplary embodiment of the present invention.

FIG. 6 is a diagram for describing a mapping table (forwarding table) between 5-tuple and a segment list according to an exemplary embodiment of the present invention.

FIG. 7 is a diagram for describing a multi-path configuring procedure using a segment list in a path controller according to an exemplary embodiment of the present invention.

FIG. 8 is a diagram for describing an example of an implementation method of a path controller according to an exemplary embodiment of the present invention.

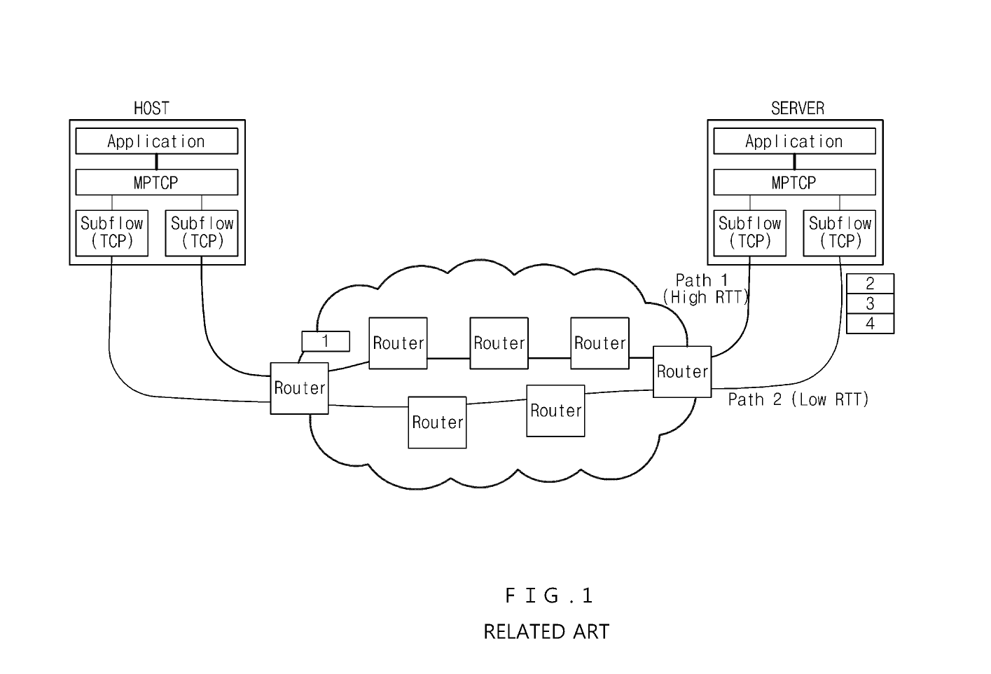

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, some exemplary embodiments of the present invention will be described in detail with reference to the exemplary drawings. When reference numerals refer to components of each drawing, it is noted that although the same components are illustrated in different drawings, the same components are designated by the same reference numerals as possible. In describing the exemplary embodiments of the present invention, when it is determined that the detailed description of the known components and functions related to the present invention may obscure understanding of the exemplary embodiments of the present invention, the detailed description thereof will be omitted.

Terms such as first, second, A, B, (a), (b), and the like may be used in describing the components of the exemplary embodiments of the present invention. The terms are only used to distinguish a component from another component, but nature or an order of the component is not limited by the terms. Further, if it is not contrarily defined, all terms used herein including technological or scientific terms have the same meanings as those generally understood by a person with ordinary skill in the art. Terms which are defined in a generally used dictionary should be interpreted to have the same meaning as the meaning in the context of the related art, and are not interpreted as an ideal meaning or excessively formal meanings unless clearly defined in the present application.

First, a server on a network mentioned in the present invention may be a device of a company providing a digital multimedia service, such as an Internet service provider, or the like and the host corresponds to a device using the digital multimedia service provided from the server on the network. For example, the host and the server may interlock with each other through a wired/wireless network supporting wired Internet communication, wireless Internet communication such as WiFi, WiBro, and the like, mobile communication such as WCDMA, LTE, and the like, or wireless access in vehicular environment (WAVE) wireless communication. The host includes wired terminals such as a desktop PC, other communication dedicated terminals, and the like and besides, the host may include wireless terminals such as a smart phone, a speech/video telephone call available wearable device, a tablet PC, a notebook PC, and the like according to a communication environment.

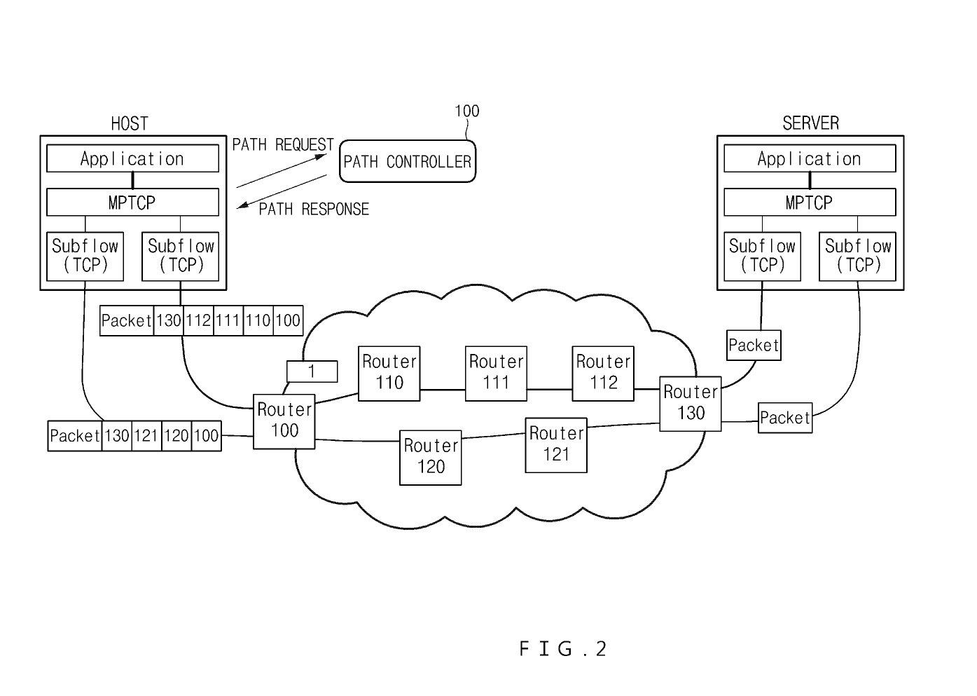

FIG. 2 is a diagram for describing a method for routing multi-paths based on a host (host based multi-path routing scheme) using a segment list according to an exemplary embodiment of the present invention.

Referring to FIG. 2, when a host supporting an MPTCP through an application transmits a data packet to a server, and the like on a network through respective subflows by using multi-paths (e.g., simultaneously using two or more paths of 3G, LTE, WiFi, WiBro, WAVE, and like), the host needs to select a path which satisfies service level agreement (SLA) in bidirectional transmissions delay (RTT), and the like among paths between the host and the server.

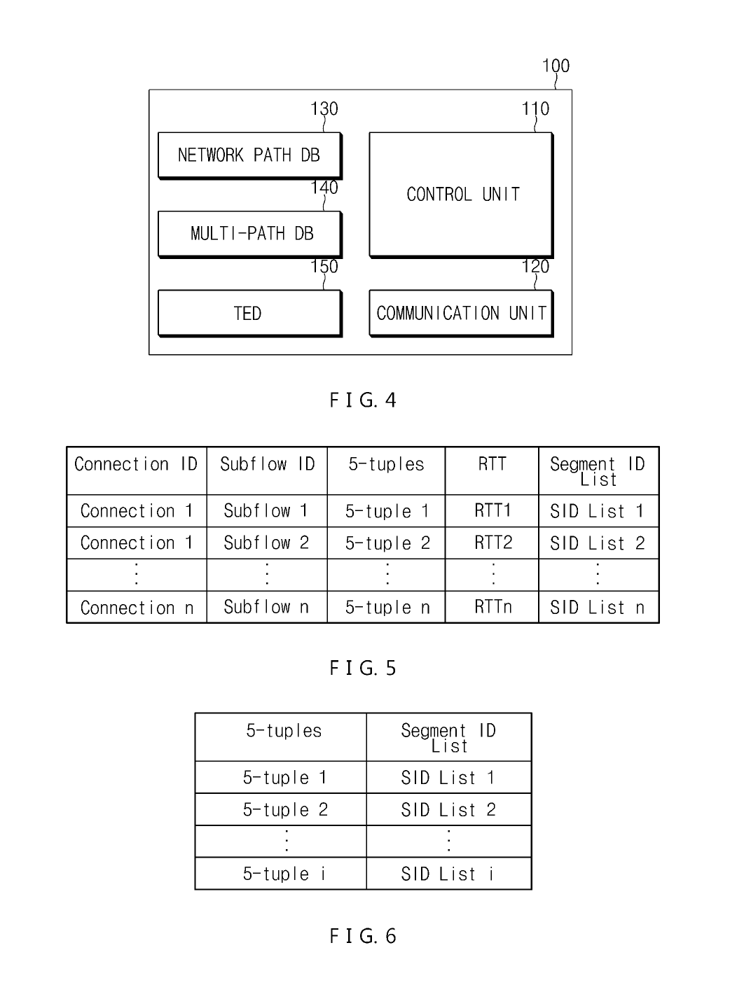

The host transmits a path request message to a path controller 100 on the network in order to select a transmission path suitable for each subflow. The path controller 100 selects the appropriate transmission path of each subflow and transmits a path response message including information on the corresponding transmission path to the host by referring to network path information obtained from a router providing network path information on the network or obtained by another method on the network and traffic engineering database (TED) (see reference numeral 150 of FIG. 4).

Herein, the transmissions path is represented as a segment list constituted by unique identifiers (or ID numbers) of routers through which a packet passes in the order of the unique identifiers of the routers. For example, in FIG. 2, a first transmission path in which the packet is transmitted through a first subflow is a segment list (130, 112, 111, 110, and 100) and a second transmission path in which the packet is transmitted through a second subflow is a segment list (130, 121, 120, and 100). Each segment may be represented as an ID number uniquely representing each router on the transmission path, that is, a predetermined number (32 or 64 bits) or an IP address. The host represents the router through which the host needs to pass by attaching the segment list to the packet to designate the transmission path toward the server. When each router on the transmission path receives the packet to (in) which the segment list is attached (included), each router transmits to a next router the packet to which the corresponding segment list from which a segment corresponding thereto is deleted is attached by deleting the segment corresponding thereto and referring to a next segment.

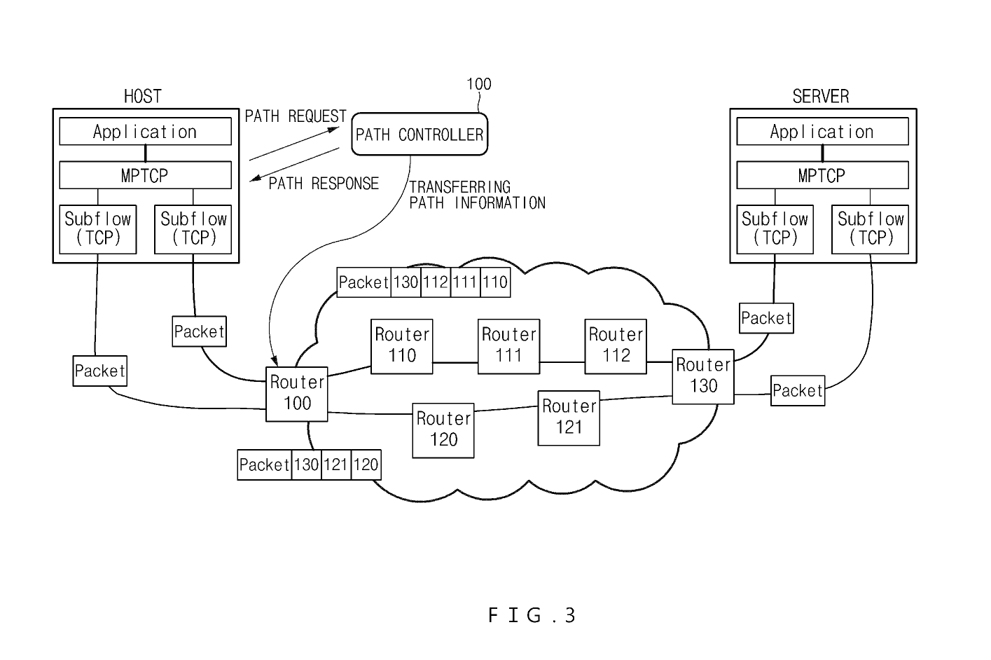

FIG. 3 is a diagram for describing a method for routing multi-paths based on network (network based multi-path routing scheme) using a segment list according to an exemplary embodiment of the present invention.

FIG. 3 is different from the method of FIG. 2 in that the path controller 100 directly announces the transmission path information, that is, the segment list to a head-end router (e.g., Router100) instead of the host. The head-end router (e.g., Router100) corresponds to a frontmost router on the network accessed by the host.

First, the host supporting the Multi-path Transmission Control Protocol (MPTCP) transmits the path request message (including a source IP address, a destination IP address, and the like) to the path controller 100 in order to select the transmission path suitable for each subflow. The path controller 100 selects the appropriate transmission path and transmits a path response message including information on the corresponding transmission path to the host by referring to network path information obtained from the router or obtained by another method on the network and a traffic engineering database (TED) (see 150 of FIG. 4). Further, the path controller 100 notifies the transmission path information (segment list) of each subflow and 5-tuple (the source (e.g., host) IP address, the destination (e.g., server) IP address, a protocol, a source port number, and a destination port number) information to the head-end router (e.g., Router100).

When the head-end router (e.g., Router100) stores and manages the transmission path information (segment list) and the 5-tuple information in a forwarding table (see FIG. 6) and the host transfers the corresponding packet to the head-end router (e.g., Router100) in order to transmit the packet to the server, the head-end router (e.g., Router100) adds the transmission path information (segment list) to the packet transmitted from the host by referring to the 5-tuple information and transmits the added packet to the next router by referring to the segment list. Next, when each router receives the packet, each router transmits the corresponding packet to the next router in the same manner as or similarly to a host based scheme by referring to the segment list included therein.

For example, in FIG. 3, when the host transmits the packet to the head-end router (e.g., Router100) through the first subflow, the head-end router (e.g., Router100) transmits the corresponding packet including the segment list of first path information to the next router (e.g., Router110) by referring to the segment list (e.g., (130,112,111,110,100)) of the corresponding first path information. Further, when the host transmits the packet through the second subflow, the head-end router (e.g., Router100) transmits the corresponding packet including the segment list of the second path information to the next router (e.g., Router120) by referring to the segment list (e.g., (130,121,120,100)) of the corresponding second path information. Next, when each router (e.g., (130,112,111)/(130,121)) receives the packet, each router transmits the corresponding packet to the next router in the same manner as or similarly to the host based scheme by referring to the segment list included therein.

As described above, the method of FIG. 3 has a simpler function than that of FIG. 2 because the host does not directly add the segment list to the packet.

FIG. 4 is a block diagram for describing components of the path controller 100 according to an exemplary embodiment of the present invention.

Referring to FIG. 4, the path controller 100 according to the exemplary embodiment of the present invention includes a control unit 110, a communication unit 120, a network path database (DB) 130, a multi-path DB 140, and the traffic engineering database (TED) 150. The respective components of the path controller 100 may be implemented by hardware, software, or a combination thereof.

The control unit 110 executes an overall control of the respective components of the path controller 100. The control unit 110 may be implemented by using a semiconductor processor, and the like and implemented to include functions of some or all of other components of the path controller 100.

The communication unit 120 may include a communication interface (e.g., a modem) which communicates with an external interface such as the host and the router and transmit/receive a required signal/data in link with the host and the router through the communication interface.

The network path DB 130 manages network path information (connection information of the router to which the transmission packet may be transferred) obtained from the routers on the network by using an interior gateway protocol (IGP) routing protocol such as open shortest path first (OSPF), intermediate system to intermediate system (IS-IS), and the like and segment routing information (e.g., a predetermined transfer range of the transmission packet for each grouped segment/IP addresses of the router to which the transmission packet is transferred for each of the predetermined grouped segments) obtained by using a segment routing technique.

The multi-path DB 140 manages information specialized to the multi-path TCP (MPTCP) as illustrated in FIG. 5. That is, with respect to the respective multi-paths of the hosts constituting the multi-paths, the multi-path DB 140 includes a connection ID, a subflow ID constituting each connection, 5-tuple corresponding to the subflow, a transmission delay value (RTT), and the segment list.

The traffic engineering database (TED) 150 manages quality of service (QoS) information such as transmission delay, transmission loss, and the like on the network path.

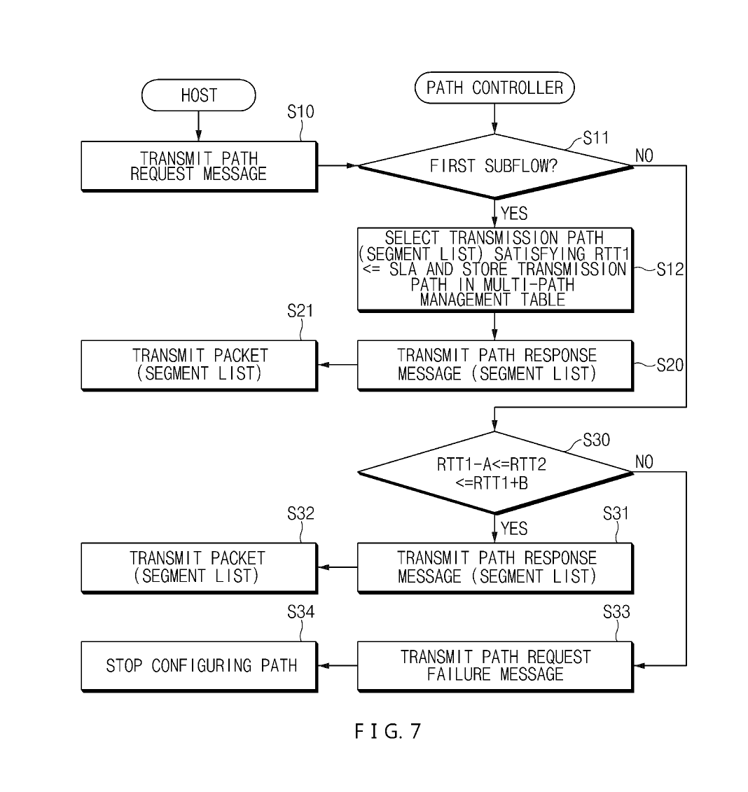

FIG. 7 is a diagram for describing a multi-path routing procedure using a segment list in a path controller 100 according to an exemplary embodiment of the present invention.

First, the host supporting the MPTCP transmits the path request message to the path controller 100 in order to select the transmission paths suitable for the subflows of a plurality of respective subflows before transmitting the packet to the server (S10).

The control unit 110 of the path controller 100 selects the transmission path so as to satisfy a transmission delay (RTT1) of a predetermined service level agreement (SLA) value or less (RTT1<=SLA) and stores the selected transmission path in a multi-path management table of the multi-path DB 140 (S12), by referring to the network path information and the segment routing information of the network path DB 130, the quality of service (QoS) information of the network path of the traffic engineering database (TED) 150, and the like and transmits a path response message including the corresponding transmission path information (segment list) to the host (S20), with respect to the path request message of the first subflow of the host received through the communication unit 120 (S11). In the method of FIG. 3, the control unit 110 may transmit the path response message including the 5-tuple information and the transmission path information (segment list) to the head-end router (e.g., Router100) of the host.

The host adds the segment list received from the path controller 100 through the path response message to the packet of the corresponding first subflow or transmits the segment list as illustrated in FIG. 2 or transmits the packet of the corresponding first subflow in order to be routing-controlled by the head-end router (e.g., Router100) as illustrated in FIG. 3 (S21).

Next, the control unit 110 of the path controller 100 selects the transmission path so as to satisfy a transmission delay (RTT2) in a predetermined difference range ((RTT1−A)˜(RTT1+B)) in the previous transmission delay (RTT1−A<=RTT2<=RTT1+B) (S30) and stores the selected transmission path in a multi-path management table of the multi-path DB 140 (S12), by referring to the network path information and the segment routing information of the network path DB 130, the quality of service (QoS) information of the network path of the traffic engineering database (TED) 150, and the like and transmits a path response message including the corresponding transmission path information (segment list) to the host (S31), with respect to the path request message of each subflow after a second subflow of the host received through the communication unit 120 (S11). In the method of FIG. 3, the control unit 110 may transmit the path response message including the 5-tuple information and the transmission path information (segment list) to the head-end router (e.g., Router100) of the host.

The host adds the segment list received from the path controller 100 through the path response message to the packet of the corresponding each subflow or transmits the segment list as illustrated in FIG. 2 or transmits the packet of the corresponding subflow in order to be routing-controlled by the head-end router (e.g., Router100) as illustrated in FIG. 3 (S32).

In step S30, thresholds A and B are set so as to prevent capability deterioration which occurs by a difference (RTT1−RTT2) between the previous transmission delay (RTT1) and the current transmission delay (RTT2) from being worse than that the TCP single path transmission method. Capability evaluation is performed by measurement and simulation, and as a result, appropriate A and B may be determined so that the multi-path scheme in which the host simultaneously uses multiple communication interfaces has a smaller transmission delay than the single path transmission method in which the host transmits the packet by using a single path by a single communication interface. In this case, RTT1+B may be determined as a smaller value (min(SLA, RTT1+B) between the service level agreement (SLA) value and RTT1+B.

In step S30, when the control unit 110 may not select a path in which the transmission delay satisfies a condition of RTT1−A<=RTT2<=RTT1+B, the control unit 110 transmits a path request failure message to the host (S33). In this case, the host stops configuring the path (S34).

In measuring the capability for the transmission delay (RTT), both the RTTs of an access interval and a network interval (an interval to pass through the routers on the network) between the host and the network are included. In particular, since a transmission delay deviation between WiFi and 3G/LTE access intervals is large, the transmission path may be determined by further giving a weighted value to a transmission delay (RTT) characteristic of the access interval. The first subflow and each subflow thereafter may be distinguished by using parameters (e.g., MP_Capable, MP_Join, Key, Token, and the like) included in a signal for session configuration, such as synchronize (SYN), SYN/acknowledgement (ACK), ACK messages, and like which are exchanged in TCP session configuration between the host and the server.

In the present invention, it is well-known that the subflow path may be determined based on other capability quality metrics other than the RTT and an operator policy in configuring the subflow path.

The present invention may be applied to various network techniques including multi-protocol label switching (MPLS), IPv4, IPv6, and the like.

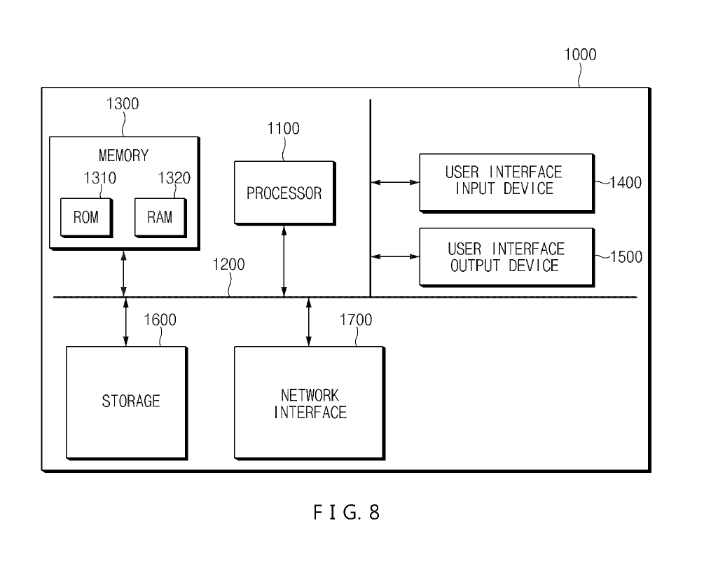

FIG. 8 is a diagram for describing an example of an implementation method of a path controller 100 according to an exemplary embodiment of the present invention. The path controller 100 according to the exemplary embodiment of the present invention may be achieved by hardware, software, or a combination thereof. For example, the path controller 100 may be implemented as a computing system 1000 illustrated in FIG. 8.

The computing system 1000 may include at least one processor 1100, a memory 1300, a user interface input device 1400, a user interface output device 1500, a storage 1600, and a network interface 1700 connected through a bus 1200. The processor 1100 may be a semiconductor device that executes processing of commands stored in a central processing unit (CPU) or the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Therefore, steps of a method or an algorithm described in association with the exemplary embodiments disclosed in the specification may be directly implemented by hardware and software modules executed by the processor 1100, or a combination thereof. The software module may reside in storage media (that is, the memory 1300 and/or the storage 1600) such as a RAM, a flash memory, a ROM, an EPROM, an EEPROM, a register, a hard disk, a removable disk, and a CD-ROM. The exemplary storage medium is coupled to the processor 1100 and the processor 1100 may read information from the storage medium and write the information in the storage medium. As another method, the storage medium may be integrated with the processor 1100. The processor and the storage medium may reside in an application specific integrated circuit (ASIC). The ASIC may reside in the user terminal. As yet another method, the processor and the storage medium may reside in the user terminal as individual components.

As described above, according to the method for configuring the multi-paths using the path controller 100 in the present invention, the subflow transmission path is configured by using the segment routing so that a capability difference of the multi-path TCP maintains a predetermined range by effectively applying a multi-transmission control protocol (TCP) technique to improve capability deterioration which may occur due to the difference in capability between the respective subflows of the multi-paths. The above description just illustrates the technical spirit of the present invention and various changes and modifications can be made by those skilled in the art to which the present invention pertains without departing from an essential characteristic of the present invention.

Therefore, the exemplary embodiments disclosed in the present invention are used to not limit but describe the technical spirit of the present invention and the scope of the technical spirit of the present invention is not limited by the exemplary embodiments. The scope of the present invention should be interpreted by the appended claims and it should be analyzed that all technical spirit in the equivalent range thereto is intended to be embraced by the scope of the present invention.

1. (canceled)

2. (canceled)

3. (canceled)

4. (canceled)

5. (canceled)

6. (canceled)

7. A method for controlling a transmission based on multiple paths, the method comprising:
determining, by a path controller, a first path among the multiple paths for transmitting a first packet from a first node to a second node; and
transmitting, by the path controller to the first node, first transmission path information including information indicating the first path,
wherein the first transmission path information includes a list indicating an order of entities through which the first packet passes,
wherein the first packet includes the first transmission path information, and
wherein, based on the first transmission path information, the first packet is transferred from the first node to a next node on the first path.

8. The method of claim 7, the method further comprising:
determining, by the path controller, a second path among the multiple paths for transmitting a second packet from the first node to the second node; and
transmitting, by the path controller to the first node, second transmission path information including information indicating the second path,
wherein the second transmission path information includes a list indicating an order of entities through which the second packet passes,
wherein the second packet includes the second transmission path information, and
wherein, based on the second transmission path information, the second packet is transferred from the first node to a next node on the second path.

9. The method of claim 8, wherein the first path and the second path are determined based on information on the first packet and the second packet.

10. The method of claim 9, wherein the information on the first packet and the second packet includes Quality of Service (QoS) information of a network path related to the first packet and QoS information of a network path related to the second packet.

11. The method of claim 7, wherein the multiple paths correspond to a set of paths having different characteristics for transmitting packets from the first node to the second node.

12. The method of claim 11, wherein the different characteristics include different radio access technologies.

13. The method of claim 8, wherein the first packet and the second packet are transferred from another node to the first node, or the first packet and the second packet are generated by the first node.

14. A path controller for controlling a transmission based on multiple paths, the path controller comprising:
a communication unit; and
a control unit,
wherein the control unit is configured to
determine a first path among the multiple paths for transmitting a first packet from a first node to a second node; and
transmit, to the first node using the communication unit, first transmission path information including information indicating the first path,
wherein the first packet includes the first transmission path information, and
wherein, based on the first transmission path information, the first packet is transferred from the first node to a next node on the first path.

15. The path controller of claim 14,
wherein the control unit is further configured to:
determine a second path among the multiple paths for transmitting a second packet from the first node to the second node; and
transmit, to the first node using the communication unit, second transmission path information including information indicating the second path,
wherein the second packet includes the second transmission path information, and
wherein, based on the second transmission path information, the second packet is transferred from the first node to a next node on the second path.

16. The path controller of claim 15, wherein the first path and the second path are determined based on information on the first packet and the second packet.

17. The path controller of claim 16, wherein the information on the first packet and the second packet includes Quality of Service (QoS) information of a network path related to the first packet and QoS information of a network path related to the second packet.

18. The path controller of claim 14, wherein the multiple paths correspond to a set of paths having different characteristics for transmitting packets from the first node to the second node.

19. The path controller of claim 18, wherein the different characteristics include different radio access technologies.

20. The method of claim 15, wherein the first packet and the second packet are transferred from another node to the first node, or the first packet and the second packet are generated by the first node.

21. A method for performing a transmission based on multiple paths, the method comprising:
receiving, by a first node from a path controller, first transmission path information including information indicating a first path determined by the path controller among the multiple paths for transmitting a first packet from the first node to a second node; and
transferring, by the first node to a next node on the first path, the first packet including the first transmission path information,
wherein the first transmission path information includes a list indicating an order of entities through which the first packet passes.

22. The method of claim 21, the method farther comprising:
receiving, by the first node from the path controller, second transmission path information including information indicating a second path determined by the path controller among the multiple paths for transmitting a second packet from the first node to the second node; and
transferring, by the first node to a next node on the second path, the second packet including the second transmission path information,
wherein the second transmission path information includes a list indicating an order of entities through which the second packet passes.

23. The method of claim 22, wherein the first path and the second path are determined based on information on the first packet and the second packet.

24. The method of claim 23, wherein the information on the first packet and the second packet includes Quality of Service (QoS) information of a network path related to the first packet and QoS information of a network path related to the second packet.

25. The method of claim 21,
wherein the multiple paths correspond to a set of paths having different characteristics for transmitting packets from the first node to the second node, and
wherein the different characteristics include different radio access technologies.

26. The method of claim 22, wherein the first packet and the second packet are transferred from another node to the first node, or the first packet and the second packet are generated by the first node.
